(19) United States
(12) Patent Application Publication
(10) Pub. No.: US 2018/0230734 A1
(43) Pub. Date: Aug. 16, 2018

(54) GLASS ELEMENT

(71) Applicant: PR Germany GmbH, Koeln (DE)

(72) Inventor: Peter Reinecke, Nuembrecht (DE)

(21) Appl. No.: 15/708,467

(22) Filed: Sep. 19, 2017

(30) Foreign Application Priority Data
Sep. 19, 2016 (DE) 10 2016 217 917.9

(51) Int. Cl. E06B 3/663

(52) U.S. Cl. CPC E06B 3/66352; E06B 3/66366; E06B 3/66319; E06B 3/66328

(57) ABSTRACT

The invention relates to a glass element (1) having at least a first panel (2), which is formed from glass, at least a second panel (3) and at least one intermediate layer (8), wherein the intermediate layer (8) is arranged between the first panel (2) and the second panel (3). The first panel (2) has a first side (4) and a second side (5), wherein the first side (4) is arranged on the intermediate layer (8). An adapter unit (15) is adhesively bonded to the first side (4) of the first panel (2) and has a spacer plate (9). The intermediate layer (8) extends from the first panel (2) to the second panel (3) with a first longitudinal extent (L1). The spacer plate (9) extends from the first panel (2) to the second panel (3) with a second longitudinal extent (L2). The first longitudinal extent (L1) is identical to the second longitudinal extent (L2).

The invention relates to a glass element, for example a glass window, a glass partition wall or a glass door for a shower.

Such glass elements from the prior art are usually produced from laminated safety glass. A laminated-safety-glass is a composite arrangement made up of two glass panels (that is to say a first glass panel and a second glass panel), between which a tear-resistant sheet is arranged. The sheet is produced, for example, from polyvinyl butyral (PVB) or ethylenevinyl acetate (EVA). A fixed connection between the two glass panels and the sheet is achieved by means of lamination. During the laminating process, for example the two glass panels and the sheet are pressed one onto the other and then heated. This gives rise to a durable connection between the two glass panels and the sheet.

The prior art also discloses glass elements which have a cavity which is formed by at least two glass panels, and/or at least two glass units in the form of laminated safety glass, and in which an insulating gas is incorporated. Such a glass element is also referred to as insulating glass or laminated insulating glass.

In order to fasten a known glass element, or in order to fasten components on a known glass element, hinges and/or fittings are arranged on the known glass element. For this purpose, a through-passage bore is arranged in each of the two glass panels of the known glass element. The two through-passage bores of the glass panels are in alignment with one another. A fastening unit of the fitting and/or of the hinge projects through the through-passage bores. Using through-passage bores, however, has the disadvantage that outer surfaces of the glass element are not completely planar. When the glass elements are cleaned by virtue of being wiped using a wiper, such as a squeegee, it is therefore easy to knock against the fastening unit. This makes it difficult to achieve quick and sufficiently good cleaning of the glass element when use is made of the wiper. Furthermore, it is possible, for example, for water to pass through the through-passage bores. On the one hand, this is undesirable and, on the other hand, the penetration of water encourages delamination, that is to say the detachment of the two glass panels and of the sheet from one another. This is not desirable.

When through-passage bores run through glass panels of an insulating-glass unit, gas can escape from the cavity. For this reason, the prior art provides for at least one gas-sealing element in the form of a tube to be positioned through the through-passage bores. This is very laborious and, accordingly, cost-intensive.

Furthermore, provision is made, in the case of the known glass elements, for fittings and/or hinges to be fastened in the glass elements by pressure being exerted from the outer side of the first glass panel in the direction of the sheet and by pressure being exerted from the outer side of the second glass panel in the direction of the sheet. However, this may result in pinching of the sheet in the region of the fitting and/or of the hinge. Such pinching reduces the functioning of the sheet in the laminated safety glass. The composite arrangement of the two glass panels and of the sheet is weakened as a result. Furthermore, this pressure generates shearing movements and vibratory movements in the region of the fitting, and therefore air, moisture or possibly chemicals can penetrate into the composite arrangement and cause delamination.

The invention is based on the problem of specifying a glass element which is made up of laminated safety glass with a fastening for a fitting and in the case of which the composite arrangement between the glass panels and sheet, without any external influences, is sufficiently stable.

This object is achieved according to the invention by a glass element having the features of claim 1. Further features of the invention can be gathered from the accompanying description, the accompanying claims and/or the accompanying drawings.

The glass element according to the invention has at least a first panel, which is formed from glass. Furthermore, the glass element according to the invention has at least a second panel. An intermediate layer is arranged between the first panel and the second panel. The intermediate layer is designed, for example, in the form of a sheet. Provision is thus made, in the case of the glass element according to the invention, for the first panel to be arranged on the intermediate layer and for the intermediate layer, in turn, to be arranged on the second panel.

Provision is also made, in the case of the glass element according to the invention, for the first panel to have a first side and a second side. In particular, provision is made for the first side to be arranged opposite the second side. The first side of the first panel is arranged on the intermediate layer. Accordingly, the first side is designed in the form of an inner side of the first panel. In contrast, the second side of the first panel is designed in the form of an outer side of the first panel. The second panel has, for example, a third side and a fourth side. In particular, provision is made for the third side to be arranged opposite the fourth side. The third side of the second panel is arranged on the intermediate layer. Accordingly, the third side is designed in the form of an inner side of the second panel. In contrast, the fourth side of the second panel is designed in the form of an outer side of the second panel.

The glass element according to the invention also has an adapter unit. In particular, provision is made for the adapter unit to be formed from metal. For example, the adapter unit is formed from stainless steel. Provision is also made, for example, for the adapter unit to be formed wholly, or also just partially, from metal. An example of the suitable metal is stainless steel. However, the invention is not restricted to this. Rather, it is possible to use any metal, or any metallic composition, which is suitable for the invention. In particular, provision is made for the adapter unit to be formed from a material which has a strength like that of metal. For example, the adapter unit is produced from ceramic material.

Provision is made, then, for the adapter unit to be adhesively bonded to the first side of the first panel by means of a curable glass/material adhesive, in particular a glass/metal adhesive. In other words, the adapter unit is fastened on the first side of the first panel by adhesive bonding by means of the curable glass/material adhesive. Provision is made, in particular, for the adapter unit not to project beyond the outer surfaces of the first panel and of the second panel. The adapter unit serves for accommodating components, for example fastening units of a fitting and/or of a hinge.

The adapter unit of the glass element according to the invention has at least one spacer plate, which extends along the first panel and the second panel. For example, the spacer plate extends only along a predetermined part of the first panel and of the second panel. Furthermore, the spacer plate extends, for example, between the first panel and the second panel and therefore spaces apart the first panel from the second panel. In particular, provision is made for the spacer plate not to extend along the entire first panel and the entire second panel. The spacer plate is formed, in particular, from stainless steel. However, the invention is not restricted to this. Rather, it is possible to use any metal, or any metallic composition, which is suitable for the invention. To this extent, it is possible, in further embodiments, for the spacer plate to be formed from aluminum and/or a material which has a strength like that of metal. For example, the spacer plate may be produced from ceramic material and/or a plastics material which has a strength like that of metal.

The intermediate layer encloses the spacer plate. In other words, the intermediate layer is arranged around the spacer plate. The intermediate layer extends from the first panel to the second panel with a first longitudinal extent. Therefore, the intermediate layer has a thickness between the first panel and the second panel which corresponds to the first longitudinal extent. Furthermore, the spacer plate extends from the first panel to the second panel with a second longitudinal extent. Accordingly, the spacer plate has a thickness between the first panel and the second panel which corresponds to the second longitudinal extent. In the case of the glass element according to the invention, the first longitudinal extent is identical, or essentially identical, to the second longitudinal extent. In other words, the intermediate layer has the same thickness as the spacer plate. The first longitudinal extent and the second longitudinal extent are, for example, up to 1 mm, up to 3 mm or up to 5 mm. However, the invention is not restricted to these values of the first longitudinal extent or of the second longitudinal extent. Rather, it is possible for the first longitudinal extent and the second longitudinal extent to be of any suitable value.

The invention has the advantage that, even in the case of pressure being exerted from the outer side of the first panel in the direction of the intermediate layer, and from the outer side of the second panel in the direction of the intermediate layer, there is no pinching of the intermediate layer in the region of a fitting and/or of a hinge. The aforementioned spacer plate prevents this pinching. This ensures that the intermediate layer, designed for example in the form of a sheet, always functions properly in the laminated safety glass.

The invention also makes it possible to reduce shearing movements and vibratory movements in the region of the fitting, and therefore less air and moisture and fewer chemicals can penetrate into the composite arrangement made up of the first panel, of the second panel and the intermediate layer and cause delamination. Provision is made, in the case of one embodiment of the glass element according to the invention, for just one of the two panels to have a through-passage bore. Therefore, the other one of the two panels has a side with a panel surface which is planar. It is then a straightforward task to wipe this side using a wiper, such as a squeegee, in order for this side to be cleaned and dried.

The invention also ensures the arrangement of a fitting and/or of a hinge on an insulating-glass comprising several panels, since it is possible for just one of the panels to have a through-passage opening. The cavity, which contains the insulating gas and is formed by further panels, is also enclosed in a sealed manner, and therefore it is not possible for any gas to escape from the cavity of the insulating glass and/or there is no need for any laborious sealing measures to be undertaken.

The glass element according to the invention is designed, for example, in the form of a frameless glass element. In the case of further embodiments, the glass element according to the invention is designed in the form of a door, of a glass wall and/or of a window. For example, the glass element according to the invention is designed in the form of a door of a shower. It is explicitly pointed out that the invention is not restricted to the aforementioned uses. Rather, the glass element according to the invention can be used for any purpose.

The form and the longitudinal extent of the spacer plate can be selected in dependence on the thickness of the first panel and of the second panel and of the desired transfer of a load arranged on the glass element. It is thus always ensured that sufficient load transfer is available. Furthermore, the invention ensures particularly good esthetics. If only one of the panels has a through-passage bore, the other panel has exclusively flush surfaces. Only the spacer plate, which may be for example in the form of a fitting, can be seen from the outer side of the other panel.

In the case of one embodiment of the glass element according to the invention, provision is made in addition, or as an alternative, for the adapter unit to have at least one fastening unit, which is arranged on a through-passage opening of the second panel. In particular, provision is made for the fastening unit to be accessible to a user through the through-passage opening on the second panel, so that further units can be installed on the glass element. In the case of this embodiment, it is possible for the first panel not to have any through-passage opening. The fastening unit is arranged in the through-passage opening of the second panel such that the fastening unit is not in contact with a periphery of the through-passage opening. For example, provision is made for the fastening unit to be designed in the form of a threaded element. This embodiment has the advantage that transfer of a load (for example a hinge) arranged on the fastening unit takes place centrally in the composite arrangement between the first panel, the sheet and the second panel. The through-passage opening of the second panel is basically not subjected to loading. This achieves high levels of load transfer.

In the case of a further embodiment of the glass element according to the invention, provision is made in addition, or as an alternative, for the glass element to have a plurality of fastening units. For example, the fastening unit is designed in the form of a first fastening unit. The adapter unit of this embodiment has, in addition, a second fastening unit. The second fastening unit is arranged on a through-passage opening of the first panel. Provision is thus made, in the case of this embodiment, for a through-passage opening and a fastening unit to be arranged both in the first panel and in the second panel. In particular, provision is made for the second fastening unit to be designed in the form of a threaded element. The second fastening unit is arranged, for example, such that the second fastening unit is not in contact with a periphery of the through-passage opening of the first panel.

In the case of yet another embodiment of the glass element according to the invention, provision is made in addition, or as an alternative, for the glass/material adhesive, in particular the glass/metal adhesive, to be an acrylate-based adhesive which can be cured by means of light. For example, the glass/material adhesive, in particular the glass/metal adhesive, can be cured by UV light. Furthermore, provision is made, for example, for the glass/material adhesive, in particular the glass/metal adhesive, to have a thermal resistance up to 120° C. In the case of yet another embodiment, provision is made for the glass/material adhesive, in particular the glass/metal adhesive, also briefly to have a resistance up to 150° C.

In the case of one embodiment of the glass element according to the invention, provision is made in addition, or as an alternative, for the first panel, the second panel and/or the intermediate layer to be transparent.

In the case of the glass element according to the invention, provision is made, in particular, for the intermediate layer to be formed from polyvinyl butyral (PVB) and/or ethylenevinyl acetate (EVA). Furthermore, in the case of a further embodiment of the glass element according to the invention, provision is made in addition, or as an alternative, for the intermediate layer to be multilayered. Provision is thus made, for example, for the intermediate layer to have at least a first layer and at least a second layer. A further embodiment provides for use to be made of at least three layers, that is to say a first layer, a second layer and a third layer. However, the first longitudinal extent of the intermediate layer formed by all the layers always remains identical to the second longitudinal extent of the spacer plate.

In the case of yet another embodiment of the glass element according to the invention, provision is made in addition, or as an alternative, for the second panel to be formed from glass or from plastics material. Accordingly, it is not absolutely necessary for the second panel to be formed from glass. It may also be formed from a plastics material, for example from Plexiglas.

The invention will be described in more detail hereinbelow with reference to embodiments. In the figures:

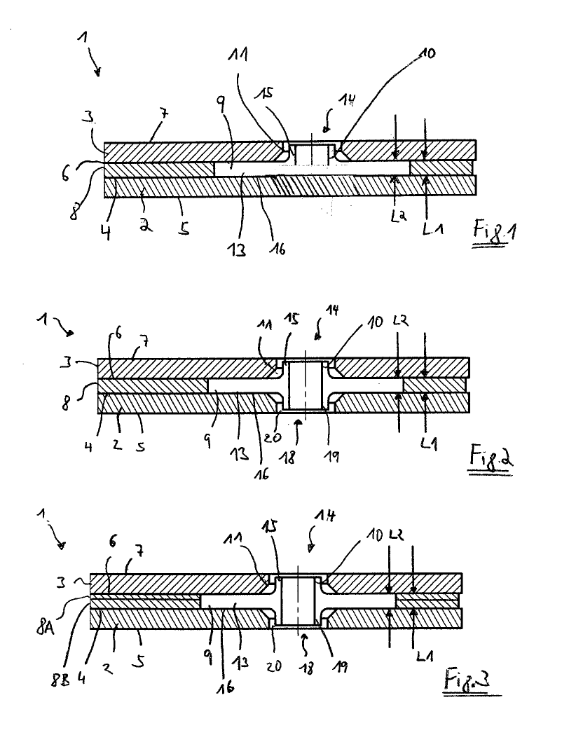

FIG. 1 shows a sectional view of a first embodiment of a glass element with an adapter unit;

FIG. 2 shows a sectional view of a second embodiment of a glass element with an adapter unit; and

FIG. 3 shows a sectional view of a third embodiment of a glass element with an adapter unit.

FIG. 1 shows a sectional view of a glass element 1 according to the invention. The glass element 1 is designed, for example, in the form of a door, of a glass wall and/or of a window. For example, the glass element 1 according to the invention is designed in the form of a door of a shower. It is explicitly pointed out that the invention is not restricted to the aforementioned use. Rather, the glass element 1 according to the invention can be used for any suitable purpose.

The glass element 1 has a first panel 2, which is formed from glass. The first panel 2 has a first side 4 and a second side 5. The first side 4 is arranged opposite the second side 5. The glass element 1 according to the invention also has a second panel 3, which is provided with a first side 6 and a second side 7. The first side 6 of the second panel 3 and the second side 7 of the second panel 3 are arranged opposite one another. Both the first panel 2 and the second panel 3 are formed from toughened safety glass having a thickness of 4 mm. It is pointed out that the invention is not restricted to this embodiment. Rather, the invention can use any glass thickness which is suitable for the invention. Furthermore, it is not absolutely necessary for the second panel 3 to be formed from glass. Rather, the second panel 3 may also be formed from plastics material, in particular from Plexiglas.

An intermediate layer 8 is arranged between the first panel 2 and the second panel 3. The intermediate layer 8 is arranged on the first panel 2 and the second panel 3 such that an interspace between the first panel 2 and the second panel 3 is essentially completely filled.

The first side 4 of the first panel 2 is basically an inner side of the first panel 2. In contrast, the second side 5 of the first panel 2 is designed in the form of an outer side of the first panel 2. The case is somewhat similar for the second panel 3. Here, the first side 6 of the second panel 3 is basically an inner side of the second panel 3. In contrast, the second side 7 of the second panel 3 is designed in the form of an outer side of the second panel 2.

The intermediate layer 8 is arranged both on the first side 4 of the first panel 2 and on the first side 6 of the second panel 3. The intermediate layer 8 is formed from polyvinyl butyral (PVB) or ethylenevinyl acetate (EVA). The intermediate layer 8 is arranged on the first side 4 and on the first side 6, for example, by lamination, which has already been explained above and to which reference is now made here.

Furthermore, in the case of this embodiment of the glass element 1, provision is made for the first panel 2, the second panel 3 and the intermediate layer 8 each to be formed from a transparent material.

The glass element 1 according to the invention has a sub-region 13 in which the intermediate layer 8 is interrupted. A first through-passage opening 14 of the second panel 3 is arranged in the sub-region 13. Also in the sub-region 13, an adapter unit 15 made of metal is adhesively bonded to the first side 4 of the first panel 2 by an acrylate-based adhesive 16. The adhesive 16 can be cured by means of light, for example by means of UV light. In order for the first panel 2, the intermediate layer 8, the second panel 3 and the adapter unit 15 to be arranged in a fixed manner on one another, provision is made, for example, for the aforementioned units to be connected to one another by a heat treatment. Such a heat treatment is disclosed, for example, in DE 10 2007 017 971 A1, of which the content is incorporated here in full in this application. The glass element 1 is thus designed in the form of a composite element.

The adapter unit 15 is formed, for example, from stainless steel. However, the invention is not restricted to this. Rather, use can be made of any metal, or any metallic composition, which is suitable for the invention. In particular, provision is made for the adapter unit 15 to be formed from a material which has a strength like that of metal. For example, the adapter unit 15 is produced from ceramic material.

The adapter unit 15 of the glass element 1 has a spacer plate 9 in the form of a metal plate which extends in the sub-region 13 along the first panel 2 and the second panel 3. The spacer plate 9 is enclosed by the intermediate layer 8. The spacer plate 9 basically replaces the intermediate layer 8 in the sub-region 13. The spacer plate 9 is formed from stainless steel. However, the invention is not restricted to this. Rather, use can be made of any metal, or any metallic composition, which is suitable for the invention. To this extent, in the case of further embodiments, the spacer plate 9 may be formed from aluminum, and/or a material which has a strength like that of metal. For example, the spacer plate 9 may be produced from ceramic material and/or a plastics material having a strength like that of metal.

The intermediate layer 8 extends from the first panel 2 to the second panel 3 with a first longitudinal extent L1. Therefore, the intermediate layer 8 has a thickness between the first panel 2 and the second panel 3 which corresponds to the first longitudinal extent L1. Furthermore, the spacer plate 9 extends from the first panel 2 to the second panel 3 with a second longitudinal extent L2. Accordingly, the spacer plate 9 has a thickness between the first panel 2 and the second panel 3 which corresponds to the second longitudinal extent L2. The first longitudinal extent L1 is identical to the second longitudinal extent L2 in the glass element 1. In other words, the intermediate layer 8 has the same thickness as the spacer plate 9. The first longitudinal extent L1 and the second longitudinal extent L2 are, for example, up to 1 mm, up to 3 mm or up to 5 mm. However, the invention is not restricted to these values of the first longitudinal extent L1 or of the second longitudinal extent L2. Rather, the first longitudinal extent L1 and the second longitudinal extent L2 may be of any suitable value.

The adapter unit 15 has a first fastening unit 10 in the form of a threaded element, which is arranged on the first through-passage opening 14 of the second panel 3. In particular, provision is made for the first fastening unit 10 to be accessible to a user through the first through-passage opening 14 on the second panel 3, so that further units can be installed on the glass element 1. In the case of this embodiment, the first panel 2 has no through-passage opening. The first fastening unit 10 is arranged in the first through-passage opening 14 of the second panel 3 such that the first fastening unit 10 and the adapter unit 15 are not in contact with a periphery 11 of the first through-passage opening 14.

FIG. 2 shows a further sectional illustration of the glass element 1 according to the invention. The embodiment according to FIG. 2 is based on the embodiment according to FIG. 1. Like reference signs denote like components. In contrast to the embodiment according to FIG. 1, the embodiment of FIG. 2 has a second through-passage opening 18 arranged in the first panel 2. The second through-passage opening 18 is in alignment with the first through-passage opening 14. Furthermore, the adapter unit 15 has a second fastening unit 19 in the form of a threaded element. The second fastening unit 19 is arranged in the second through-passage opening 18 of the first panel 2. Provision is thus made, in the case of this embodiment of FIG. 2, for a respective through-passage opening and a respective fastening unit to be arranged both in the first panel 2 and in the second panel 3. The second fastening unit 19 is arranged in the second through-passage opening 18 such that the second fastening unit 19 and the adapter unit 15 are not in contact with a periphery 20 of the second through-passage opening 18 of the first panel 2. In the case of the embodiment according to FIG. 2, the adapter unit 15 is formed in one piece. In the case of a further embodiment (not illustrated), the adapter unit is formed, for example, from more than one part, wherein each respective part of the adapter unit is assigned to one of the through-passage openings.

FIG. 3 shows a further sectional illustration of the glass element 1 according to the invention. The embodiment according to FIG. 3 is based on the embodiment according to FIG. 2. Like reference signs denote like components. In contrast to the embodiment according to FIG. 2, the intermediate layer 8 of the embodiment of FIG. 3 is formed in more than one part. Therefore, the intermediate layer 8 is formed from a first layer 8A and a second layer 8B.

The glass element 1 has the advantage that, even in the case of pressure being exerted from the second side 5 of the first panel 2 in the direction of the intermediate layer 8, and from the second side 7 of the second panel 3 in the direction of the intermediate layer 8, there is no pinching of the intermediate layer 8. The spacer plate 9 prevents this pinching. This ensures that the intermediate layer 8 always functions properly in the laminated safety glass.

The glass element 1 also makes it possible to reduce shearing movements and vibratory movements in the region of the first fastening unit 10 and/or the second fastening unit 19, and therefore less air and moisture and possibly fewer chemicals can penetrate into the composite arrangement made up of the first panel 2, the second panel 3 and the intermediate layer 8 and cause delamination.

In the case of the embodiment of the glass element 1 according to FIG. 1, just one of the two panels 2, 3, that is to say the second panel 3, is provided with a through-passage opening. Therefore, the first panel 2 has the second side 5 with a panel surface, forming an outer surface, which is planar. It is then a straightforward task to wipe the second side 5 using a wiper, such as a squeegee, in order for the second side 5 to be cleaned and dried.

The glass element 1 also ensures the arrangement of a fitting and/or of a hinge on an insulating-glass comprising several panels, since it is possible for just one of the panels to have a through-passage opening. The cavity, which contains the insulating gas and is formed by further panels (not illustrated), is also sealed, and therefore it is not possible for any gas to escape from the cavity of the insulating glass or there is no need for any laborious sealing measures to be undertaken.

The features of the invention which are disclosed in the present description, in the drawings and in the claims may be essential both individually and in any desired combinations for the purpose of realizing the various embodiments of the invention. The invention is not restricted to the embodiments described. It can be varied within the framework of the claims and taking into account the knowledge of a competent person skilled in the art.

### LIST OF REFERENCES

1 Glass element
2 First panel
3 Second panel
4 First side of the first panel
5 Second side of the first panel
6 First side of the second panel
7 Second side of the second panel
8 Intermediate layer
8A First layer
8B Second layer
9 Spacer plate (for example a metal plate)
10 First fastening unit
11 Periphery
13 Sub-region of the glass element
14 First through-passage opening of the second panel
15 Adapter unit made of metal
16 Adhesive
18 Second through-passage opening of the first panel
19 Second fastening unit
20 Periphery
L1 First longitudinal extent
L2 Second longitudinal extent

1. A glass element (1) having
at least a first panel (2), which is formed from glass,
at least a second panel (3), and
at least one intermediate layer (8), wherein the intermediate layer (8) is arranged between the first panel (2) and the second panel (3),
wherein
the first panel (2) has a first side (4) and a second side (5), wherein the first side (4) is arranged on the intermediate layer (8),
an adapter unit (15) is adhesively bonded to the first side (4) of the first panel (2) by means of a curable glass/material adhesive (16),
the adapter unit (15) has a spacer plate (9), wherein the spacer plate (9) extends along the first panel (2) and the second panel (3),
the intermediate layer (8) extends from the first panel (2) to the second panel (3) with a first longitudinal extent (L1),
the spacer plate (9) extends from the first panel (2) to the second panel (3) with a second longitudinal extent (L2), and
the first longitudinal extent (L1) is identical to the second longitudinal extent (L2).

2. The glass element (1) as claimed in claim 1, wherein the glass element (1) has at least one of the following features:
the adapter unit (15) is formed from metal;
the adapter unit (15) is formed from stainless steel;
the adapter unit (15) is formed from a material which has a strength like that of metal;
the adapter unit (15) is produced from ceramic material;
the spacer plate (9) is designed in the form of a metal plate;
the spacer plate (9) is formed from stainless steel;
the spacer plate (9) is formed from a material which has a strength like that of metal;
the spacer plate (9) is produced from plastics material;
the spacer plate (9) is produced from ceramic material;
the glass/material adhesive (16) is a glass/metal adhesive.

3. The glass element (1) as claimed in claim 1 or 2, wherein
the adapter unit (15) has a fastening unit (10),
the fastening unit (10) is arranged on a through-passage opening (14) of the second panel (3), and
the fastening unit (10) is arranged in the through-passage opening (14) and is not in contact with a periphery (11) of the through-passage opening (14).

4. The glass element (1) as claimed in claim 3, wherein the fastening unit (10) is designed in the form of a threaded element.

5. The glass element (1) as claimed in claim 3 or 1, wherein
the fastening unit (10) is a first fastening unit,
the adapter unit (15) has a second fastening unit (19), and
the second fastening unit (19) is arranged on a through-passage opening (19) of the first panel (2).

6. The glass element (1) as claimed in claim 5, wherein the second fastening unit (19) is designed in the form of a threaded element.

7. The glass element (1) as claimed in claim 1, wherein the glass/material adhesive is an acrylate-based adhesive which can be cured by means of light.

8. The glass element (1) as claimed in claim 1, wherein the first panel (2), the second panel (3) and/or the intermediate layer (8) are transparent.

9. The glass element (1) as claimed in claim 1, wherein the intermediate layer (8) is formed from polyvinyl butyral (PVB) and/or ethylenevinyl acetate (EVA).

10. The glass element (1) as claimed in claim 1, wherein the intermediate layer (8) has at least a first layer (8A) and at least a second layer (8B).

11. The glass element (1) as claimed in claim 1, wherein the second panel (3) is formed from glass and/or plastics material.

12. The glass element (1) as claimed in claim 1, wherein the spacer plate (9) extends in a sub-region (13) along the first panel (2) and the second panel (3), wherein the spacer plate (9) is enclosed by the intermediate layer (8), and wherein the spacer plate (9) replaces the intermediate layer (8) in the sub-region (13).
